(19) United States
(12) Patent Application Publication
(10) Pub. No.: US 2015/0347079 A1
(43) Pub. Date: Dec. 3, 2015

(54) Electronic device for determining when an officer is in a foot pursuit, a fight, has been incapacitated, or shots have been fired

(71) Applicant: LifeSaver Int'l Inc, MIssion Viejo, CA (US)

(72) Inventors: William Pat Price, Henderson, NV (US); Ted Titmus, Mission Viejo, CA (US)

(21) Appl. No.: 14/724,071

(22) Filed: May 28, 2015

Related U.S. Application Data
(60) Provisional application No. 62/004,361, filed on May 29, 2014.

(51) Int. Cl. G06F 3/16; H04R 3/00

(52) U.S. Cl. CPC G06F 3/16; H04R 3/005

(57) ABSTRACT

Detecting the current state and status of a police officer. The invention can detect when an officer is in a foot pursuit, in an altercation with another person, is in proximity to gunshots, and when an officer is incapacitated. The invention is used to monitor the operational status of a police officer. The invention includes a hand held device which has a three axis accelerometer, three axis gyroscope, microphone, one or more microprocessors, cellular radio, and a camera. Measurements relating to physical movements of the officer are made by interpreting the outputs from the accelerometer, gyroscope, and the microphone. These outputs are constantly analyzed for patterns and when a threat pattern is recognized, the device will communicate the officer's status, state and position to a central authority.

This application claims priority from provisional application No. 62/004,361, filed May 29, 2015, the entire contents of which are herewith incorporated by reference.

### FIELD OF INVENTION

The field of invention relates to electronic devices that sense and interpret motion and sense and interpret sounds.

### BACKGROUND

Acoustic detection of gunfire or gunshots is well known in the art. These systems are generally composed of multiple high-tech microphones mounted on telephone and light poles and on high surfaces of buildings. These microphones “continuously listen” to ambient sounds and when a sound is detected with a fast rise time, software algorithms to determine the rise time, peak sound, and the decay rate will analyze the sound in real time. Gunshots have very well understood characteristics that can be analyzed by large computers. Once a gunshot sound is detected, the time of arrival at different microphones of the same sound allows computers, through triangulation, to determine an approximate geographical area where the gunshot originated. A second type of acoustic detection of gunfire or gunshots is through the use of portable or mobile detectors. These detectors will generally listen for a basic acoustic waveform that approximates a gunshot. Once such a waveform is detected it is uploaded to a central computer for additional analysis. A second type of mobile detection is used in mobile devices where the analysis is performed on the mobile device. These types of mobile devices are generally mounted in police vehicles with portable high performance computers due to the amount of computer processing needed to perform the analysis.

Methods for monitoring persons running are well known in the art. Smart Phones have had the ability to monitor personal walking and running and for generating a map showing the path a person has taken while walking or running. Generally these types of sensors rely on a GPS sensor to determine the personal physical location. Some of these devices will not only plot a map track of the path taken but also the periodic speed and elevation gain and loss.

### SUMMARY

The inventors recognize that what is needed is needed is some way to monitor sounds and personal motion of police officers to determine when an officer is in foot pursuit, involved in an altercation, when gun shots are detected close by an officer, and when an officer is incapacitated.

The present invention includes a portable or mobile hand held device designed to collect real time data consisting of body movement acceleration, GPS position, audio analysis of audio for gunshots and body movement and heart rate. These data are analyzed by algorithms to determine if an officer needs help and if the officer is in a threatening tactical situation.

### BRIEF DESCRIPTION OF THE DRAWINGS

FIG. 1 is a depiction of the functional components of the invention.

FIG. 2 is a depiction of a logic diagram that describes the process of constructing the gunshot fingerprint database.

FIG. 3 is a depiction of a logic diagram that describes the process of reporting a false negative gunshot like sound, identifying the sound, and cataloging the sound in the database as a gunshot.

FIG. 4 is a depiction of a logic diagram that describes the process when a valid gunshot has been detected by the device.

FIG. 5 is a depiction of a logic diagram that describes the match fingerprint function.

### DETAILED DESCRIPTION OF THE INVENTION

The present application refers to an audio or acoustic fingerprint, which is a condensed digital summary, deterministically generated from an audio signal that can be used to identify an audio sample or quickly locate similar items in an audio database.

Reference will now be made in detail to various embodiments, examples of which are illustrated in the accompanying drawings. Wherever possible, the same reference numbers will be used throughout the drawings to refer to the same or like parts.

In a preferred embodiment, a gunshot detector is disclosed. The gunshot detector preferably compares a footprint of the sound against a fingerprint database of sounds, rather than analyzing rise, fall, peak, and duration and levels of a sound bit. The database is constructed through recording a plurality of different gunshots from different scenarios, e.g., outside a vehicle, inside a vehicle with the windows rolled up, and inside a vehicle with the windows rolled down. The gunshot recordings are recorded from long barrel guns (rifles), short barrel auto loading guns, and short barrel revolving cylinder guns.

The recordings are made with the fired guns pointing directly away from the recording apparatus, angled toward the recording apparatus, and pointed vertically in relation to the recording apparatus. In this embodiment, the recordings will be analyzed and normalized for each orientation of a gun and for physical placement of the recording apparatus. The resulting database will be generated where a numerical value or fingerprint will represent the analyzed and normalized sounds of the gunshots.

When a portable gunshot detector being carried by a police officer “hears”, what may be a gunshot, the sound is analyzed and a fingerprint of the sound generated. The footprint is then compared against the database resident in the gunshot detector being carried by the officer. If a close match of the generated audio fingerprint is found in the resident database, the gunshot detector speaks a warning of, “GUNSHOT”, to the officer then contacts a dispatcher by sending one or more metadata packages containing the matched gunshot fingerprint from the database and the fingerprint recorded by the gunshot detector along with the officer's identity, tactical state, and GPS location.

In another preferred embodiment, the officer wears a heart rate sensor such as those found in athletic heart rate monitors. These monitors may be contained in a band that wraps around the chest or wraps around the arm and communicates via a radio frequency link to a display. The heart rate sensor may also be contained in a watch that runners wear that displays the runner's heart rate on the front of the watch.

In the present embodiment, a heart rate sensor is fixed to the officer and sends heart rate sensor data to a communications device carried by the officer that can communicate with a dispatcher. This preferred embodiment also has a multi-axis accelerometer and a gyroscope. These two sensors allow the communications device, through mathematical algorithms to determine that the officer may be involved in a foot pursuit, a fight, or if the officer has been injured or killed. In any of these tactical situations, the device will have the capability to send metadata packages to a dispatcher. The metadata can contain the officer's heart rate, GPS position for movement, and other data.

The communications device can differentiate the actions of an officer walking and running. Using heart rate data in addition to movement rate data, the communications device can tell if the officer is walking or running. If the GPS device indicates that the officer is running and his heart rate has accelerated, the communications device will determine that he is in a foot pursuit. If the officer is not moving from a relatively small geographically position and his heart rate accelerates, and the multi-axis accelerometer and gyroscope are indicating rapid movement, the device will assume that the officer is involved in a physical altercation. If the communications device determines that the officer is not physically moving or has fallen and the heart rate sensor determines that the officer's heart rate has dropped to a very low rate and/or has stopped, the communications device will determine that he is severely injured, wounded, or has been killed by an assailant or involved in a fatal accident. If the communications device determines that any of these tactical situations have occurred, it sends metadata packages to a dispatcher.

In another preferred embodiment, the communications device can have a training mode whereby the officer that carries the device will engage in various training scenarios while dressed in full work gear and running in a simulated foot pursuit, engaging in a simulated fight, sitting in a vehicle and once his heart rate drops to a normal level, having other personnel firing weapons outside the vehicle and through open windows of the vehicle. The result of these training scenarios is the construction of a database of movement types, heart rates, physical movements, and determinations.

Additionally, this preferred embodiment will collect and save data for later processing and inclusion into the scenario database on a periodic basis.

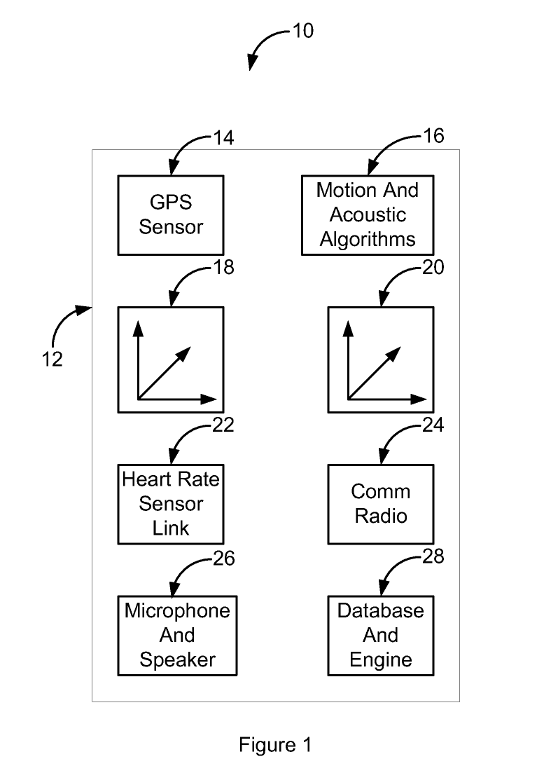

Now referencing FIG. 1 where 10 depicts the functional components of the invention. The invention has a device 12 which is a mobile computing device with a GPS sensor 14, a three axis accelerometer 18, a three axis gyroscope 20, a heart rate sensor 22, a comm radio 24, a microphone 26, a database and database engine 28, and motion and acoustic algorithms 16.

In this depiction, microphone and speaker 26 detect sounds in an police officer's environment and separate out sounds with a short duration and fast rise and decay times. Those sounds are processed and an acoustical fingerprint created through the use of one or more algorithms of the plurality of algorithms 16. The resulting suspect fingerprint is matched against a database of gunshot fingerprints by database and engine 28. If a match of the suspect fingerprint is made then the device will alert the officer of a positive ID of a gunshot by outputting the word “GUNSHOT” through the speaker of microphone and speaker 26. While the search for a match is taking place, the device will gather the outputs from three axis accelerometer 18 and three axis gyroscope 20 and heart rate sensor link 22. These data will make a determination of the officer's current tactical status such as (1) in a foot pursuit, (2) an altercation, (3) sitting in a vehicle, (4) injured, and/or (5) killed. If the suspect acoustic fingerprint is determined to be a valid gunshot, the device will format a packet of data including the officer's GPS coordinates, tactical situation, the detected gunshot fingerprint, matched gunshot fingerprint, officer's identification, and other pertinent data. This packet will be sent via comm radio 24 to a dispatch center.

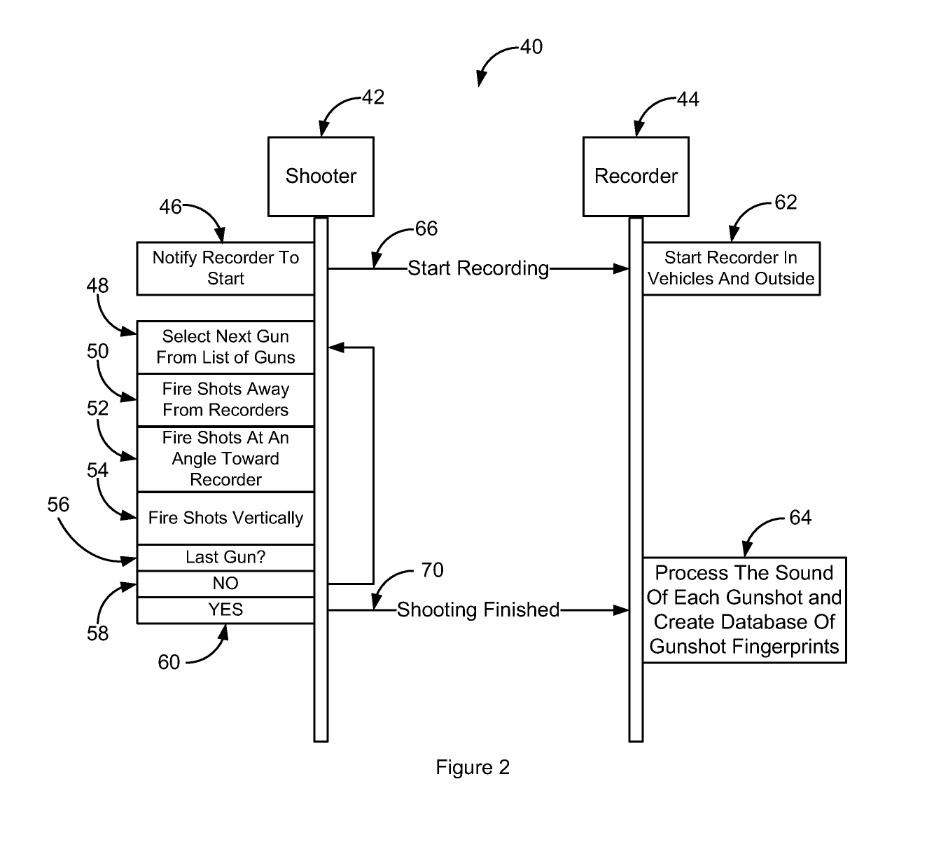

Now referencing FIG. 2, where 40 depicts the process of constructing the gunshot fingerprint database. In this depiction the Test Shooter 42 will be a human who fires a plurality of firearms whose captured sounds will be processed and acoustic fingerprints of the sounds will be used to create a database of gunshot fingerprints. Recorders 44 is a plurality of recording apparatus located near the physical position of test shooter 42. In this process there will be a minimum of four recording apparatus' where one will be located in open air, one will be located in a typical police vehicle with the windows up, one will be located in a typical police vehicle with the front seat windows open and the back seat windows closed.

The process starts with test shooter 42 at logic block 46 notify recorder to start. Signal 66 start recording is sent to the plurality of recorders 44 where the recorder operators (not shown) all start their recorders. The physical records (not shown) will be digital records with high sample rate capability.

Generation of gunshot sounds will be through the firing of a plurality of guns (not shown) including automatic handguns, revolver handguns, automatic rifles, and shotguns. Each firearm will be fired a plurality of times.

Logic block 48 select next gun from list of guns starts the collection of sounds with the test shooter picking the first gun from the list of guns to be fired. Control for the procedure then falls through to logic block 50 fire shots away from recorders. At this logic block, test shooter 42 will point the current gun in a direction substantially away from the location of the recorders. Test shooter 42 will fire a plurality of shots from the firearm after which control will fall through to logic block 52. Test shooter 42 will then fire a plurality of shots in a direction substantially toward the location of the recorders after which control will fall through to logic block 54 fire shots substantially vertically in relation to the location of the recorders after which control will fall through to logic decision block 56 last gun?

If the current gun is the last gun on the list to be fired, control will fall through to logic result block 60 YES where signal 70 shooting finished will be sent to logic block 64 process the sound of each gunshot and create database of gunshot fingerprints. If the current gun is NOT the last gun on the list to be fired, control will fall through to logic block 58 NO where control will be transferred to logic block 48 select next gun from list of guns. This loop that ranges from logic block 48 to logic block 58 will be repeated until all of the guns on the list have been fired and their sounds captured on the recording devices 44.

At the conclusion of the gun firings, the recorded sounds will be processed through acoustic fingerprinting algorithms. Acoustic fingerprinting software is well known in the art and commercially shipped in the market. The current application does not claim any art describing the algorithms of how the acoustic fingerprint is created. Each created finger print from a gunshot group will be included in the gunshot fingerprint database.

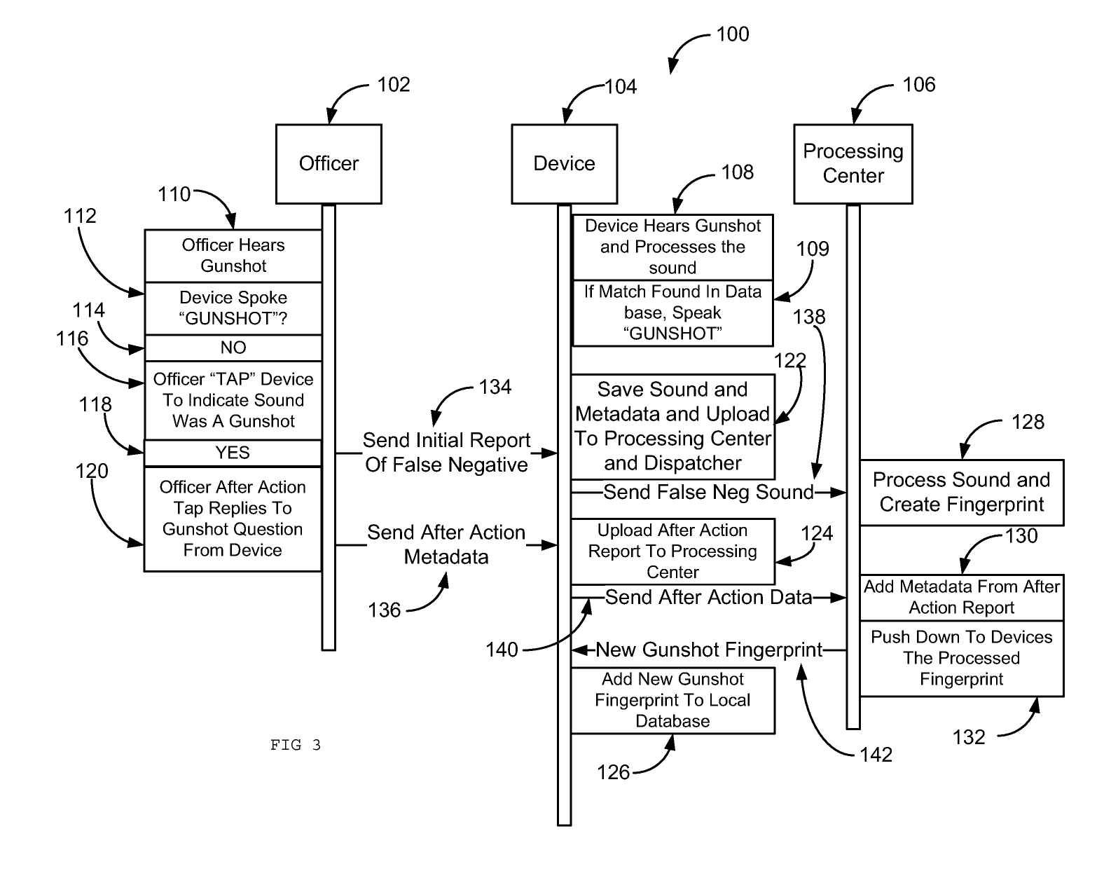

Now referencing FIG. 3 where 100 depicts a police officer 102, the device 104 and the processing center 106. In this depiction, the process starts with process block 108 Officer hears gunshot. At the same time the officer hears what may be a gunshot, device 104 hears the gunshot at logic block 108 device hears gunshot and processes the sound. Control for device 104 then falls through to logic block 109 If match found in data base, speak “GUNSHOT”. Processing for device 104 then stops.

At decision logic block 112 device spoke “GUNSHOT”? makes a determination as to device having either found or not found a match for the gunshot like sound that was captured. The captured sound may have been a gunshot that was not in the database or was not a gunshot but sounded like a gunshot. The sound may have been created by a vehicle back firing or the detonation of a firework such as a firecracker. If the sound was not a gunshot, then device 104 will not have spoken the word “GUNSHOT”. If the officer heard the sound but did not hear the device speak “GUNSHOT” then he will make a determination as to the sound being a gunshot or not.

If the officer determines that the sound was a gunshot, he will tap the case housing the device 104 indicating that the sound was a gunshot. If this was the case, control will fall through to logic result block 118 YES. This logic result block will send signal 134 send initial report of false negative to logic block 122 Save Sound and Metadata and Upload To Processing Center and Dispatcher. This logic block saves the fingerprint of the “heard” sound along with any pertinent metadata and uploads it to processing center 106 and to the dispatcher (not shown). Device 104 will then send signal 138 send false neg sound to processing center 106 logic block 128 process sound and create fingerprint.

At the same time, officer 102 will, after the incident of the false negative being reported, logic block 120 officer after action tap replies to gunshot question from device. This logic block requests the officer to complete an after action report which will describe the type and model (if known) of the firearm which was fired. This logic block will then send signal 136 send after action metadata to device 104 logic block 124 upload after action report to processing center. This logic block will send signal 140 send after action data to processing center 106 logic block 130 add metadata from after action report. Processing center 106 logic block 130 adds metadata from after action report. This process block adds the additional metadata to the fingerprint that was uploaded from device 104 and added to the acoustic fingerprint database (not shown). Control will then fall through to logic block 132 push down to devices the processed fingerprint. This logic block sends signal 142 new gunshot fingerprint to device 104. At device 104, control will fall through to logic block 126 add new gunshot fingerprint to local database. This action updates the local databases (not shown) that are resident on all devices 104.

The intended purpose of this depiction is to show how processing center 104 database and the local databases residing on devices 104 are updated in real time.

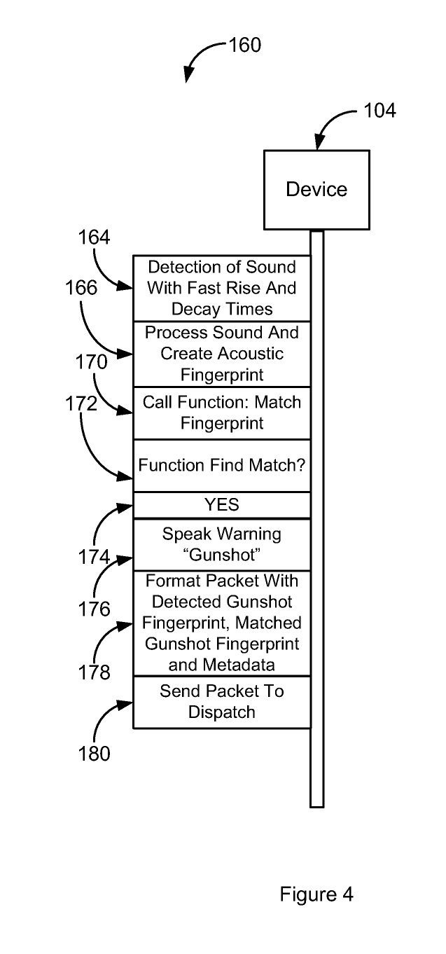

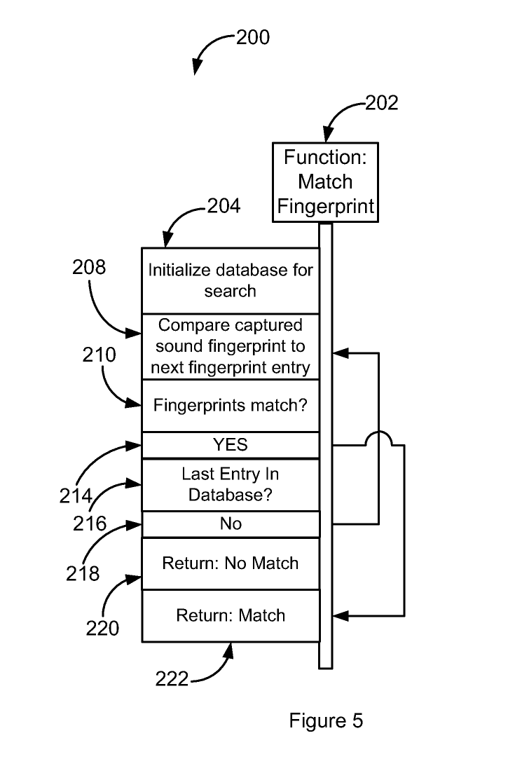

Now referencing FIG. 4 where 100 is a more detailed depiction of the actions of device 104 sensing a gunshot sound. In this depiction, the process starts at logic block 164 detection of a sound with fast rise and decay times after which control will fall through to logic block 166 process sound and create acoustic fingerprint. This action uses one or more of the acoustic fingerprint algorithms from motion and acoustic algorithms 16. After the acoustic fingerprint for the sound is created, control will fall through to logic block 170 Call Function: match fingerprint. This logic block call a function depicted and described in FIG. 5. When the function returns it will return to logic decision block 172 function find MATCH? If the return value was “MATCH”, control will fall through to result logic block 174 YES after which control will fall through to logic block 176 speak warning “GUNSHOT”. This logic block warns the officer that a shot was fired in close proximately to his physical location. Control will then fall through to logic block 178 format packet with detected gunshot fingerprint, matched fingerprint, and metadata. This logic block will build or format a data packet then control will fall through to logic block 180 send packet to dispatch. This logic block will send the packet to a dispatcher so that backup can be sent to the officer's location.

Now referencing FIG. 5 where 200 is a depiction of function: match fingerprint. In this depiction, function 202 searches the local gunshot fingerprint database for a match with a gunshot fingerprint created by device 104 after detecting a gunshot like sound. Processing for function 202 begins at logic block 204 initialize database for search. This logic block initializes several indexes used for mapping the captured fingerprint and the fingerprints contained in the database. After the database has been initialized for searching, control falls through to logic block 208 compare captured sound fingerprint to next fingerprint entry. This logic block performs a comparison with the captured fingerprint against a fingerprint in the database after which control falls through to decision logic block 210 fingerprints match? If the captured fingerprint matches the current fingerprint indexed in the local database, control will fall through to results logic block 214 which transfers control to return logic block 222 return: “Match”. If decision logic block 210 determined that the captured fingerprint did not match the current fingerprint indexed in the database control will fall through to results logic block 218 NO after which control will be transferred to logic block 208 compare captured sound fingerprint to next fingerprint entry. This completes the search loop which runs from logic block 208 to results logic block 218. If decision logic block 216 determines that the current match failed and that the current fingerprint indexed in the database is the last fingerprint indexed in the database then control will fall through to return logic block 220 return: no match.

Although only a few embodiments have been disclosed in detail above, other embodiments are possible and the inventors intend these to be encompassed within this specification. The specification describes certain technological solutions to solve the technical problems that are described expressly and inherently in this application. This disclosure describes embodiments, and the claims are intended to cover any modification or alternative or generalization of these embodiments which might be predictable to a person having ordinary skill in the art. For example, other kinds of devices can be used and more or fewer comparisons can be made.

Those of skill would further appreciate that the various illustrative logical blocks, modules, circuits, and algorithm steps described in connection with the embodiments disclosed herein may be implemented as electronic hardware, computer software running on a specific purpose machine that is programmed to carry out the operations described in this application, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments.

The various illustrative logical blocks, modules, and circuits described in connection with the embodiments disclosed herein, may be implemented or performed with a general or specific purpose processor, or with hardware that carries out these functions, e.g., a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor can be part of a computer system that also has an internal bus connecting to cards or other hardware, running based on a system BIOS or equivalent that contains startup and boot software, system memory which provides temporary storage for an operating system, drivers for the hardware and for application programs, disk interface which provides an interface between internal storage device(s) and the other hardware, an external peripheral controller which interfaces to external devices such as a backup storage device, and a network that connects to a hard wired network cable such as Ethernet or may be a wireless connection such as a RF link running under a wireless protocol such as 802.11. Likewise, external bus 18 may be any of but not limited to hard wired external busses such as IEEE-1394 or USB. The computer system can also have a user interface port that communicates with a user interface, and which receives commands entered by a user, and a video output that produces its output via any kind of video output format, e.g., VGA, DVI, HDMI, displayport, or any other form. This may include laptop or desktop computers, and may also include portable computers, including cell phones, tablets such as the IPAD™ and Android platform tablet, and all other kinds of computers and computing platforms.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, using cloud computing, or in combinations. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of tangible storage medium that stores tangible, non transitory computer based instructions. An exemplary storage medium is coupled to the processor such that the processor can read information from, and write information to, the storage medium. In the alternative, the storage medium may be integral to the processor. The processor and the storage medium may reside in reconfigurable logic of any type.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer.

The memory storage can also be rotating magnetic hard disk drives, optical disk drives, or flash memory based storage drives or other such solid state, magnetic, or optical storage devices. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. The computer readable media can be an article comprising a machine-readable non-transitory tangible medium embodying information indicative of instructions that when performed by one or more machines result in computer implemented operations comprising the actions described throughout this specification.

Operations as described herein can be carried out on or over a website. The website can be operated on a server computer, or operated locally, e.g., by being downloaded to the client computer, or operated via a server farm. The website can be accessed over a mobile phone or a PDA, or on any other client. The website can use HTML code in any form, e.g., MHTML, or XML, and via any form such as cascading style sheets (“CSS”) or other.

The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Also, the inventor(s) intend that only those claims which use the words “means for” are intended to be interpreted under 35 USC 112, sixth paragraph. Moreover, no limitations from the specification are intended to be read into any claims, unless those limitations are expressly included in the claims.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

We claim:

1. A method for creating acoustic fingerprints for gunshot sounds, the method comprising:
receiving sounds in a first high sample rate digital audio receiver,
running a software module in a processor, that analyzes sound samples within said sounds to produce an acoustic fingerprint of said sound samples,
first placing said first high sample rate digital audio receiver in a simulated environment, which simulates an environment in which a firearm shot is likely to be detected,
recording sounds using said first high sample rate digital audio receiver, including a plurality of shots of a
firearm will be shot a plurality of times, in a plurality of directions relative to said first high sample rate digital audio receiver,
said software module operating to analyze each sound of a gunshot and for each sound of a gunshot creating a acoustic footprint of said sound of a gunshot, and
averaging said fingerprints of said gunshot sounds fired in the plurality of directions to create an averaged fingerprint, and saving the averaged fingerprint in a database along with metadata associated with the fingerprints, said metadata includes at least a firearm manufacturer, model, caliber, ammunition manufacturer, bullet type, bullet weight, bullet type, and environment where said shot took place.

2. A system for a mobile gunshot detector which detects gunshot sounds and provides alerts responsive to detecting said gunshot sounds, said system comprising:
a device with a GPS sensor,
a microphone,
a speaker,
a processor,
a database containing a plurality of fingerprints of gunshot sounds and metadata associated with each of said plurality of fingerprints of gunshot sounds,
a first software program, running on said processor, analyzing sounds received by said microphone and identifying a suspect sound as a gunshot, by comparing said sounds with said fingerprints
a radio communications link that sends data to a remote location based on said identifying,
said first software program monitors sounds captured by said microphone and captures and digitizes sounds that have a fast rise time and a fast decay time which constitutes a possible gunshot sound,
said first software program analyzes said possible gunshot sound and creates an acoustic fingerprint of said possible gunshot sound, and
said first software program performs a comparison of said acoustic fingerprint of said possible gunshot sound against said database of acoustic gunshot sounds, and
said first software program operating if a match is made between said acoustic fingerprint of said possible gunshot sound and one of the acoustic fingerprints contained in said database, said first software program announcing a warning to a user of said mobile gunshot detector, and
said first software program operating to create a data packet containing a user's GPS coordinates, user's identification, the fingerprint of the gunshot sound and the metadata for the associated acoustic fingerprint matched in said database, and
said first software program operating send said data packet will be uploaded to said remote location.

3. The system as in claim 2, wherein said remote location is a law enforcement agency dispatcher.

4. A system for a mobile device capable of determining if a police officer is in danger and notifying a law enforcement agency dispatcher if it is determined that the officer is in danger, the mobile device comprising:
a device with GPS sensor,
a microphone,
a speaker,
a three axis accelerometer,
a three axis gyroscope,
a heart rate sensor receiving device,
a wearable heart rate device communicating a user's heart rate,
a radio communications link that can send data to a law enforcement agency dispatcher,
a processor, running a first software program which monitors said three axis accelerometer and said three axis gyroscope, and
monitor said heart rate sensor receiving device;
said software program operating when detecting the user starting to move in a direction at an accelerated pace or velocity, and
said user's heart rate accelerates,
said software program determining, based on the user's velocity and heart rate if the monitored data is symptomatic of the user being in a foot pursuit, and if the determination is that the user is in a foot pursuit, said software program will creating a metadata packet having at least the user's identification, time, date, GPS coordinates, and the rate that the user is running, said metadata packet will be uploaded to a law enforcement agency dispatcher;
said software program determining, based on the user's velocity, body movement as monitored by said three axis accelerometer and said three axis gyroscope and heart rate if the monitored data is symptomatic of the user being in a physical altercation, and if the determination is that the user is in a physical altercation, said software program will create a metadata packet consisting of at least the user's identification, time, date, GPS coordinates, and an indication that the user is in a physical altercation, said metadata packet will be uploaded to a law enforcement agency dispatcher;
said software program will determine, based on the user's GPS coordinates and heart rate if the user has not moved and has a heart rate event where the heart rate is substantially higher than normal, substantially lower than normal, or has stopped, and
if any of the heart rate events is detected, said software program will create a metadata packet consisting of at least the user's identification, time, date, GPS coordinates, and an indication that the user is in a medical emergency situation, and said metadata packet is uploaded to a law enforcement agency dispatcher.
